(19) United States
(12) Patent Application Publication
(10) Pub. No.: US 2023/0413134 A1
(43) Pub. Date: Dec. 21, 2023

(54) METHOD AND USER EQUIPMENT (UE) FOR OPTIMIZING MULTIPLE RF MODULE OPERATION

(71) Applicant: SAMSUNG ELECTRONICS CO., LTD., Suwon-si (KR)

(72) Inventors: Nishant, Bangalore (IN); Kailash Kumar Jha, Bangalore (IN); Avneesh Tiwari, Bangalore (IN); Subbarayudu Mutya, Bangalore (IN)

(21) Appl. No.: 18/316,654

(22) Filed: May 12, 2023

Related U.S. Application Data
(63) Continuation of application No. PCT/KR23/06289, filed on May 9, 2023.

(30) Foreign Application Priority Data
Jun. 21, 2022 (IN) 202241035606

(51) Int. Cl. H04W 36/00

(52) U.S. Cl. CPC H04W 36/0072; H04W 36/0061

(57) ABSTRACT

The present disclosure relates to a method and device for optimizing multiple radio frequency (RF) module operation of a user equipment (UE) in a wireless network. The method comprises: activating a first RF module from a plurality of RF modules available at the UE for communication with a serving beam in a serving cell while remaining RF modules are inactive, select at least one RF module from the remaining inactivate RF modules to measure at least one neighbor beam from a plurality of neighbor beams of each neighbor cell, and create a list of available neighbor beams in neighbor cells based on the measurements, determining whether a signal strength associated with the serving beam meets a signal criteria, and performing one of continuing communication with the serving beam using the first RF module in response to determining that the signal strength associated with the serving beam does not meet the signal criteria, and switching the communication from the serving beam to the at least one neighbor beam based on the measurement for continuing the communication in response to determining that the signal strength associated with the serving beam meets the signal criteria.

### CROSS-REFERENCE TO RELATED APPLICATIONS

This application is a continuation of International Application No. PCT/KR2023/006289 designating the United States, filed on May 9, 2023, in the Korean Intellectual Property Receiving Office and claiming priority to Indian Patent Application No. 202241035606, filed on Jun. 21, 2022, in the Indian Patent Office, the disclosures of which are incorporated by reference herein in their entireties.

### BACKGROUND

### Field

The disclosure relates to wireless communication and, for example, to a method and a user equipment (UE) for optimizing multiple RF module operation.

### Description of Related Art

Modern society has adapted and has become reliant upon wireless communication devices for various purposes such as, connecting users of the wireless communication devices with other users. The wireless communication devices can vary from battery powered handheld devices to stationary household and/or commercial devices utilizing electrical network as a power source.

Due to rapid development of the wireless communication devices, a number of areas capable of enabling entirely new types of communication applications have emerged. Further, due to saturation of the cellular frequency band (e.g., below 6 GHz), the Fifth Generation (5G) wireless communications technology is expected to use high frequency carriers of frequency band between 10 and 300 gigahertz (GHz) in millimeter wave (mmwave) band. Usage of the mmwave band enables transmission of high speed and high quality multimedia content through the wireless communication devices.

In order to support mmwave band, the wireless communication devices typically include multiple mmwave antennas. However, in order to save battery life, only one of the mmwave antennas is used for beam management. When the mmwave antenna is used, all patch elements or antenna elements are activated and are specific to carrier frequency of serving cell. However, when the wireless communication devices is in a good neighbour cell signal strength coverage as compared to serving cell beam, the wireless communication device cannot immediately measure a neighbour beam of a neighbour cell when the wireless communication device is in communication with the serving cell. The wireless communication device can measure the neighbour beam only when measurement gaps are provided by network when the mobile device is in communication with the serving cell, as the simultaneous measurement of other frequency cells are not possible.

Since the wireless communication device has to wait till the measurement gaps to detect any neighbour cell beam, there is a possibility of beam failure when a signal strength from the serving cell beam is very weak. Thus, it is desired to address the above mentioned disadvantages or other shortcomings or at least provide a useful alternative.

### SUMMARY

Embodiments of the disclosure provide a method implemented by a user equipment for optimizing multiple RF module operation of the UE in a wireless network. In various example embodiments of the present disclosure, the UE does not have to wait for the measurement gap. Instead, the UE measures the neighbor beam continuously or when the signal strength associated with the serving cell beam meets a first signal criteria. The first signal criteria indicates that a communication link between the UE and the serving cell or beam is weak and UE may need to search for neighbor cell or beam having a good signal strength. Thus, avoiding beam failure and also saving battery power of the UE by selectively activating only required RF modules.

Embodiments of the disclosure provide the UE that optimizes multiple RF modules operation in a wireless network. In various example embodiments of the present disclosure, the UE does not have to wait for the measurement gap. Instead, the UE measures the neighbor cell beam continuously or when the signal strength associated with the serving cell beam meets a first signal criteria. The first signal criteria indicates that a communication link between the UE and the serving cell beam is weak and UE may need to search for neighbor cell beam having a good signal strength. Thus, avoiding beam failure and also save battery power of the UE by selectively activating only required RF module.

Various example embodiments of the disclosure provide a method for optimizing radio frequency (RF) module operation of user equipment (UE) in a wireless network. The method comprises: activating a first RF module comprising at least one antenna from a plurality of RF modules available at the UE for communication with a serving beam in a serving cell while remaining RF modules from the plurality of RF modules are inactive; selecting at least one RF module from the remaining inactive RF modules to measure at least one neighbor beam from a plurality of neighbor beams of each neighbor serving cell, and creating a list of available neighbor beams in neighbor cells based on the measurements. The method may further comprise: determining whether a signal strength associated with the serving beam meets a signal criteria, and performing one of continuing the communication with the serving beam using the first RF module in response to the determining that the signal strength associated with the serving beam does not meet the first signal criteria, and switching the communication from the serving beam to the at least one a neighbor beam based on the measurements for continuing the communication module in response to the determining that the signal strength associated with the serving beam meets the first signal criteria.

In an example embodiment, the switching comprises: retrieving one or more fields from the list of available neighbor beams, wherein the one or more fields include information of neighbor cell beam band (Ncell beam Band), neighbor cell frequency (Ncell freq), neighbor cell beam identity (Ncell beam id), a direction of beam including theta and phi angles, RF module identity number, strength of signal by corresponding RF module, activating the at least one RF module from the remaining inactive RF modules using the retrieved one or more fields, and switching the communication from the serving beam to that at least one neighbor beam using the activated at least one RF module.

In an example embodiment, activating the at least one RF module comprises: determining a gain of at least one RF module from the plurality of RF modules, wherein the gain of the RF module is based on the number of antenna element in the RF module, and wherein the RF module having a greater number of antenna elements has high gain. The method may further comprise: determining a beam direction associated with the at least one RF module by measuring theta and phi angles and signal strength received at the RF module; and activating the at least one RF module based on the determined gain and beam direction.

In an example embodiment, activating the first RF module from a plurality of RF modules comprises: estimating a power loss associated with each of the plurality of RF modules, and activating the RF module having a lowest estimated power loss.

Various example embodiments of the disclosure provide a user equipment (UE) configured to optimize RF module operation. The UE comprises: a plurality of RF modules comprising at least one antenna, a memory, a processor, and a multiple RF module operation controller, communicatively coupled to the memory, the processor, and the plurality of RF modules. The multiple RF module operation controller is configured to: activate a first RF module from the plurality of RF modules available at the UE for communication with a serving beam in a serving cell, wherein remaining RF modules from the plurality of RF modules are inactive, select at least one RF module from the remaining inactive RF modules to measure at least one neighbor beams from a plurality of neighbor beams of each neighbor serving cell, create a list of available neighbor beams in neighbor cells based on the measurements, determine whether a signal strength associated with the serving beam in a serving cell or beam meets a signal criteria, perform one of continue communication with the serving beam using the first RF module in response to the determining that the signal strength associated with the serving beam not meeting the signal criteria, and switch the communication from the serving beam to the at least one neighbor beam based on the measurement for continuing the communication in response to the determining that the signal strength associated with the serving beam meets the signal criteria.

In an example embodiment, to switch the communication of the UE, the RF module operation controller is further configured to: retrieve one or more fields from the list of available neighbor beams, wherein the one or more fields include information of neighbor cell beam band (Ncell beam Band), neighbor cell frequency (Ncell beam freq), neighbor cell identity (Ncell beam id), a direction of beam including theta and phi angles, a RF module identity number, strength of signal by corresponding RF module; activate the at least one RF module from the remaining inactive RF modules using the retrieved one or more fields; and switch the communication from the serving beam to that at least one neighbor beam using the activated at least one RF module.

In an example embodiment, to activate the at least one RF module, the RF module operation controller is further configured to: determine a gain of each of the plurality of RF modules, wherein the gain is based on the number of antenna elements in the RF module, and wherein the RF module having a higher number of antenna elements has a high gain; and determine a beam direction associated with the at least one RF module by measuring theta and phi angles using the signal received corresponding RF module; and activate the at least one RF module based on the determined gain and the beam direction.

In an example embodiment, to activate the first RF module from the plurality of RF modules, the multiple RF module operation controller is further configured to: estimate a power loss associated with each of the plurality of RF modules, and activate the RF module having a lowest estimated power loss.

These and other aspects of the various example embodiments herein will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications may be made within the scope of the disclosure herein without departing from the scope thereof, and the embodiments herein include all such modifications.

### BRIEF DESCRIPTION OF THE DRAWINGS

This method and associated devices are illustrated in the accompanying drawings, throughout which like reference letters indicate corresponding parts in the various figures. The above and other aspects, features and advantages of certain embodiments of the present disclosure will be more apparent from the following detailed description, taken in conjunction with the accompanying drawings, in which:

FIG. 1A is a diagram illustrating a scenario of a wireless communication in which a UE is surrounded by serving cell and neighboring cells, according to the prior art;

FIG. 1B is a diagram illustrating a frame format of the UE for communicating with the serving cell and for measuring neighboring cell signal strength, according to the prior art;

FIG. 2 is a block diagram illustrating an example configuration of the UE for optimizing multiple RF modules operations, according to various embodiments;

FIG. 3A is a block diagram illustrating an example configuration of an RF module, according to various embodiments;

FIG. 3B is a diagram illustrating an example beam database including neighboring cell measurements, according to various embodiments; and

FIGS. 4 and 5 is a flowchart illustrating an example method for optimizing the multiple RF antenna operations, according to various embodiments.

### DETAILED DESCRIPTION

The various example embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the disclosure herein. Also, the various embodiments described herein are not necessarily mutually exclusive, as various embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the disclosure.

Various example embodiments may be described and illustrated in terms of blocks which carry out a described function or functions. These blocks, which may be referred to herein as units or modules or the like, may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block may be physically separated into two or more interacting and discrete blocks without departing from the scope of the disclosure. Likewise, the blocks of the embodiments may be physically combined into more complex blocks without departing from the scope of the disclosure.

The accompanying drawings are used to aid in easily understanding various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The terms “wireless communication device”, “mobile device”, “user equipment”, and “UE” may refer to the same device or equipment and are used interchangeably throughout this disclosure. The terms “wireless communication network” and “wireless network” may refer to the same network and are used interchangeably throughout this disclosure. The terms “mmwave antenna” and “RF module” may refer to the same device and are used interchangeably throughout this disclosure.

Accordingly, embodiments herein provide a method for optimizing multiple mmwave antenna operation of a user equipment (UE) in a wireless network. The method comprises activating a first mmwave antenna from a plurality of mmwave antenna for communication with a serving cell or beam while remaining mmwave antenna from the plurality of mmwave antenna are inactive, determining whether a signal strength (or channel state information) associated with the serving cell or beam meets a first signal criteria, and performing one of selecting at least one mmwave antenna from the remaining inactive mmwave antenna in response to the determining that the signal strength (or channel state information) associated with the serving cell or beam meets the first signal criteria, measuring at least one neighbor cell or beam from a plurality of neighbor cells or beams of the serving cell or beam using at least one selected mmwave antenna, and creating a list of neighbor cells or beams based on the measurements; and continue using the first mmwave antenna which is active to communicate with the serving cell or beam in response to the determining that the signal strength associated with the serving cell or beam does not meets the first signal criteria. For example, the channel state information may include at least one of RSSI (received signal strength indicator), RSRQ (reference signal received quality), RSRP (reference signal received power), SINR (signal to interference and noise ratio) or BER (bit error rate).

In the conventional methods and systems, in order to save battery life, only one of the mmwave antennas is used for beam management. When the mmwave antenna is used, all patch elements or antenna elements are activated and are specific to carrier frequency of serving cell. However, when the mobile device is in good neighbour cell signal strength coverage as compared to the serving cell, the mobile device cannot immediately measure neighbour cell beam when the mobile device is in communication with the serving cell. The mobile device can measure the neighbor cell beam only when measurement gaps are provided by network when the mobile device is in communication with the serving cell, as the simultaneous measurement of other frequency cells are not possible.

Unlike to the conventional methods and systems, in the present disclosure the UE does not have to wait for the measurement gap. Instead, the UE measures the neighbor beam continuously or when the signal strength associated with the serving beam meets a signal criteria. The signal criteria indicates that a communication link between the UE and the serving cell beam is weak and UE may need to search for neighbor cell beam having a good signal strength. Thus, avoiding beam failure and also save battery power of the UE by selectively activating only required mmwave antennas.

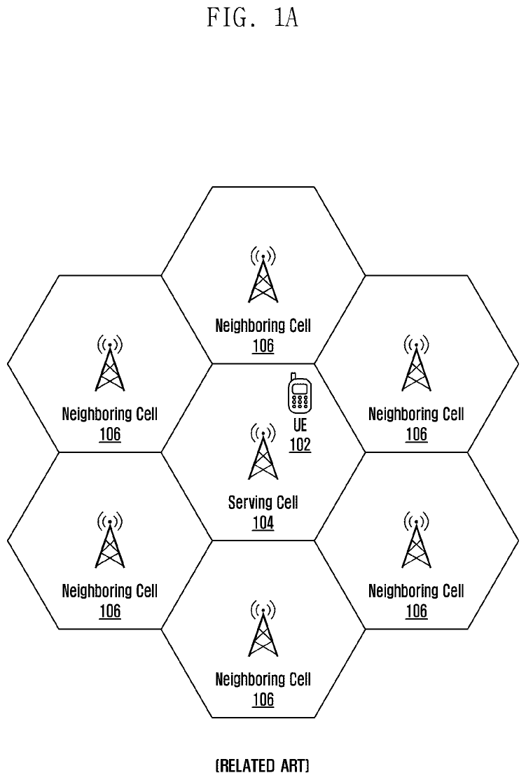

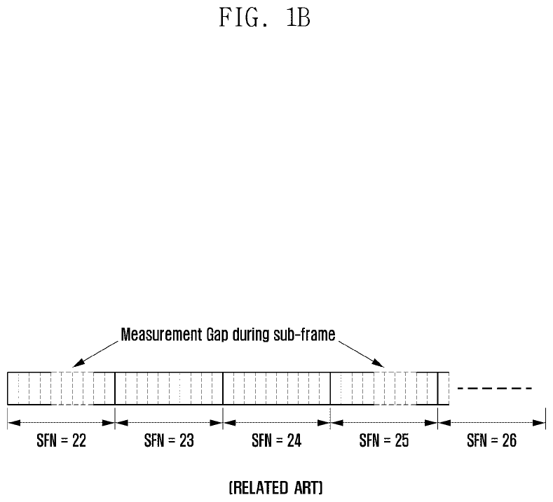

Referring now to the drawings, and more particularly to FIGS. 1A, 1B, 2, 3A, 3B, 4 and 5, where similar reference characters denote corresponding features throughout the figures, there are shown various example embodiments.

FIG. 1A is a diagram illustrating a scenario of a wireless communication in which a UE 102 is surrounded by serving cell 104 and neighboring cells 106, according to the prior arts. As depicted in FIG. 1A, the UE 102 is in vicinity of a plurality of cells and the UE 102 is connected to one of the plurality of cells known as serving cell 104 for communicating with a wireless network. During the movement of the UE 102 from one place to other, there is possibility that a communication link between the UE 102 and the serving cell 104 can become weak and the UE 102 may be in good neighbor cell 106 providing better network coverage when compared to the serving cell 104. However, the UE 102 cannot immediately measure signal strength of each beam of the neighbour cell 106 when the UE 102 is in communication with the serving cell 104. As per the existing scenario, the UE 102 has to wait till a measurement gap, as shown in FIG. 1B, to measure each beam of the neighbour cell 106 as the simultaneous measurement of other frequency cells are not possible for each beam of neighbour cell.

Since the UE 102 needs to wait till the measurement gap to detect any beam of neighbour cells 106, there is a possibility of beam failure when a signal strength from the serving cell 104 is very weak.

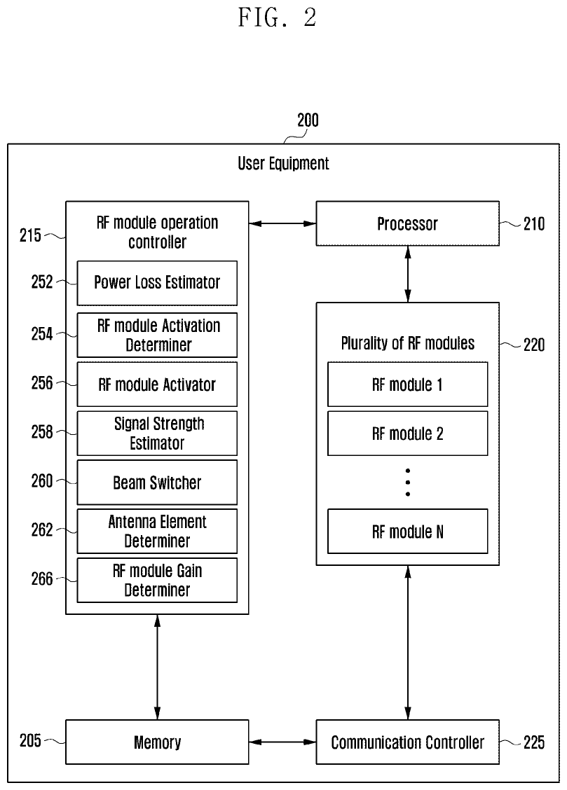

FIG. 2 is a block diagram illustrating an example configuration of the UE 200 for optimizing multiple RF module operation, according to various embodiments. In an embodiment, the UE 200 includes a memory 205, a processor (e.g., including processing circuitry) 210, a multiple RF module operation controller (e.g., including various processing/control circuitry) 215, a plurality of RF modules 220, and a communication controller (e.g., including various processing/control circuitry) 225. The multiple RF module operation controller 215 comprises various processing circuitry and/or executable program instructions including, for example, a power loss estimator 252, an RF module activation determiner 254, an RF antenna activator 256, a signal strength estimator 258, a beam switcher 260, an antenna element determiner 262, and a RF module gain determiner 266. For example, the processor 210 and the multiple RF module operation controller 215 may include different circuits or different hardware. For example, the processor 210 and the multiple RF module operation controller 215 may be logically (e.g., software) separated parts.

The memory 205 stores one or more data related to the user equipment 200, and may also store instructions to be executed by the processor 210 and the multiple RF module operation controller 215. The memory 205 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 205 may, in some examples, be considered a non-transitory storage medium. The term “non-transitory” may indicate that the storage medium is not embodied in a carrier wave or a propagated signal. However, the term “non-transitory” should not be interpreted that the memory 205 is non-movable. In some examples, the memory 205 can be configured to store larger amounts of information than the memory 205. In certain examples, a non-transitory storage medium may store data that can, over time, change (e.g., in Random Access Memory (RAM) or cache). In an embodiment, the memory 205 can be an internal storage unit or it can be an external storage unit of the user equipment 200, a cloud storage, or any other type of external storage.

The processor 210 may, for example, and without limitation, include a general purpose processor that communicates with the memory 205, the multiple RF module operation controller 215, the plurality of RF modules 220, and the communicator controller 225. The processor 210 is configured to execute instructions stored in the memory 205 and to perform various processes.

The plurality of RF modules 220 includes a set of mmwave antennas. Each of the set of mmwave antenna includes a group of phased antenna arrays.

The communication controller 225 may include various processing/control circuitry and is configured for communicating internally between internal hardware components and with external devices via one or more networks.

The multiple RF module operation controller 215 is configured to communicate with the memory 205, the processor 210, the plurality of RF modules 220, and the communicator controller 225. The multiple RF module operation controller 215 is configured to execute instructions stored in the memory 205 and to perform various processes to optimize multiple mmwave antenna operation.

In an embodiment, the power loss estimator 252 is configured to estimate a power loss associated with each of the plurality of mmwave antennas. In an embodiment, the power loss estimator 252 is configured to estimate the power loss by estimating Equivalent Isotropically Radiated Power (EIPR) loss and Effective Isotropic Sensitivity (EIS) loss. The EIPR loss is a product of transmitter power and the antenna gain in a given direction relative to an isotropic antenna of a radio transmitter. The EIS is the measured sensitivity in a single direction. The Effective Isotropic Radiated Power (EIRP) loss and Effective Isotropic Sensitivity (EIS) loss is observed in the UE 200 due to mismatch in Intermediate frequency (IF) cable lengths from each RF module to a trans-receiver of the UE 200.

Further, in an embodiment, the RF module activator 256 is configured to activate the RF module having the lowest power loss as the first RF module.

In an embodiment, the signal strength estimator 258 is configured to determine a signal strength associated with the serving cell beam 104 upon activating the first RF module by the RF module activator 256.

In an embodiment, the RF module activation determiner 254 is configured to determine whether the signal strength associated with the serving cell beam meets a first signal criteria. In one example, RF module activation determiner 254 is configured to determine whether the signal strength is below a first threshold value. The first threshold value indicates that a communication link between the UE 200 and the serving cell beam 104 is weak and UE 200 may need to search for neighbor cell beam having a good signal strength.

Further, in an embodiment, the RF module activation determiner 254 is configured to select at least one RF module from the remaining inactive RF module in response to the determining that the signal strength associated with the serving cell beam 104 meets the first signal criteria. The RF module activation determiner 254 is further configured to measure at least one neighbor cell beam from a plurality of neighbor cells beams 106 of the serving cell beam 104 using at least one selected RF module. Further, the RF module activation determiner 254 is configured to create a list of available neighbor beams based on the measurements and store the list of available neighbor beams in a beam database stored in the memory 205.

Further, in an embodiment, the RF module activation determiner 254 is configured to continue using the first RF module which is active to communicate with the serving cell beam in response to the determining that the signal strength associated with the serving cell beam does not meets the first signal criteria.

Further, in an embodiment, the RF module activation determiner 254 is configured to select at least one RF module from the remaining inactive RF modules continuously (or periodically) without using any signal criteria.

In an embodiment, the RF module activation determiner 254 is further configured to determine whether the signal strength (or channel state information) associated with the serving cell beam 104 meets a second signal criteria. In one example, the RF module activation determiner 254 is configured to determine whether the signal strength is below a second threshold value. The second threshold value indicates that a communication link between the UE 200 and the serving cell beam 104 is very weak and UE 200 need immediate switching to neighbor cell or beam having a good signal strength for avoiding a beam failure scenario.

Further, in an embodiment, the RF module activation determiner 254 is configured to select at least one RF module from the remaining inactive RF module in response to the determining that the signal strength associated with the serving cell beam meets the second signal criteria.

Further, in an embodiment, the RF module activation determiner 254 is configured to continue measure the at least one neighbor cell beam from the plurality of neighbor cells beams of the serving cell using at least one selected RF module, and updating the list of neighbor beams based on the measurements in response to the determining that the signal strength associated with the serving cell beam does not meets the second signal criteria.

In an embodiment, the beam switcher 260 is configured to switch the communication of the UE 200 from the serving cell beam 104 to the at least one neighbor cells beam 106 based on the measurement. In order to switch the communication of the UE 102 from the serving beam 104 to the at least one neighbor beams 106, the beam switcher 260 is configured to retrieve one or more fields related to the list of available neighbor beams, wherein the one or more fields include at least one of information of neighbor cell beam band (Ncell beam Band), neighbor cell beam frequency (Ncell beam freq), neighbor cell beam identity (Ncell beam id), a direction of beam including theta and phi angles, a RF module identity number, or strength of signal by corresponding RF module. The beam switcher 260 then enables the RF module activator 256 to activate the at least one RF module using the retrieved one or more fields while inactivating the plurality of RF module other than the first RF module. The beam switcher 260 is then configured to switch the communication from the serving cell beam to that at least one neighbor cells or beams using the activated RF module.

In an embodiment, the antenna element determiner 262 is configured to identify a number of antenna elements in each of the plurality of RF modules. For example, each RF module may include at least one antenna (eg, mmWave antenna). For example, each antenna may include a plurality of antenna elements.

In an embodiment, RF module gain determiner 266 is configured to determine a gain of each of the plurality of RF modules (220). The gain of each RF modules depends on a number of antenna elements in corresponding RF module. In an embodiment, the RF module having more number of antenna elements has high gain. In an embodiment, the RF module gain determiner 266 is also configured to determine a beam direction associated with each RF module by measuring the theta and phi angles and signal strength received at the RF module

In an embodiment, the RF module activator 256 is configured to activate the RF module based on the determined gain and the beam direction.

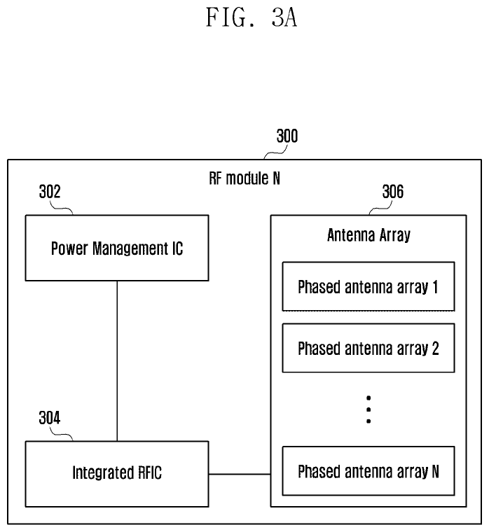

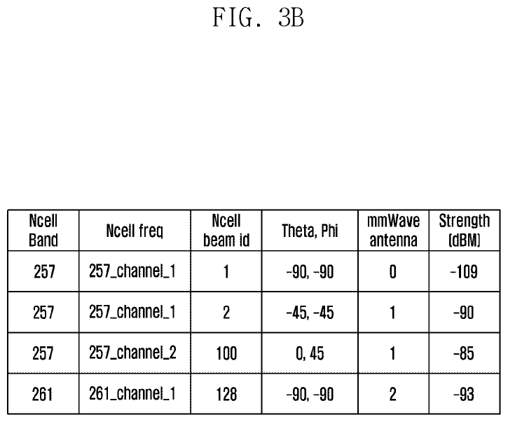

FIG. 3A is a block diagram illustrating an example configuration of the RF module 300 according to various embodiments. In an embodiment, the RF module N 300 (e.g., each of RF modules 220 of FIG. 2) comprises a power management IC 302, an integrated radio frequency integrated circuit (RFIC) 304, and an antenna array 306. The power management IC 302 is configured to provide a required power to the antenna array 306. The integrated RFIC 304 is configured to operate the antenna array 306 in a selected Radio Frequency range. The antenna array 306 include a set of phased antenna array such as phased antenna array 1, phased antenna array 2, . . . phased antenna array N.

FIG. 3B is a diagram illustrating an example beam database including neighboring cell measurements, according to various embodiments. As shown in FIG. 3B, the example beam database includes one or more fields such as ncell band, ncell frequency, ncell beam id, theta and phi angles, RF antenna identity number, and strength. The one or more fields as shown in FIG. 3B are measured during the UE when the signal strength of the first RF module meets the first signal criteria.

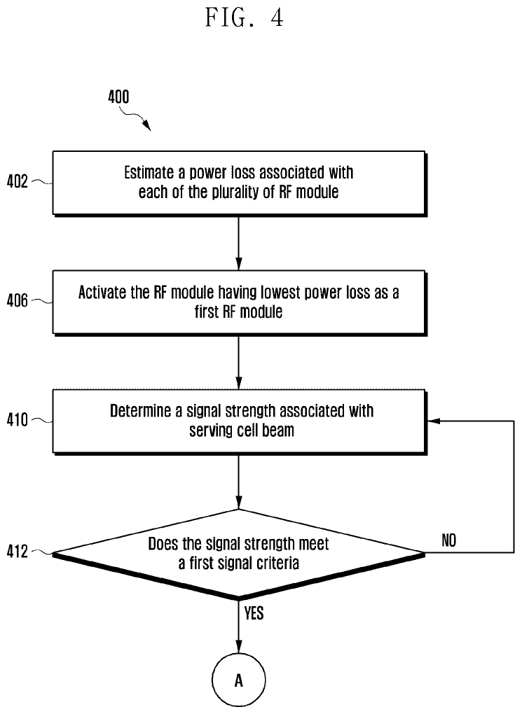

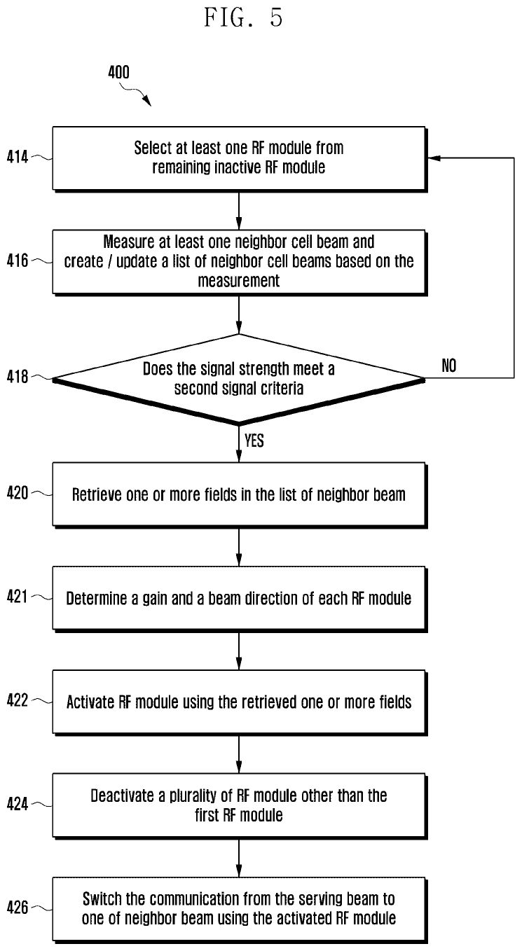

FIGS. 4 and 5 is a flowchart illustrating an example method for optimizing the multiple RF module operations, according to various embodiments.

As illustrated in FIGS. 4 and 5, the method 400 comprises one or more blocks implemented by the user equipment 200. The order in which the method 400 is described is not intended to be construed as a limitation, and any number of the described method blocks can be combined in any order to implement the method 400. Additionally, individual blocks may be deleted from the method 400 without departing from the scope of the subject matter described herein.

At 402, a power loss associated with each of a plurality of RF module is estimated. In an embodiment, the power loss estimator 252 is configured to estimate the power loss associated with each of the plurality of RF modules. In an embodiment, the power loss estimator 252 is configured to estimate the power loss by estimating Equivalent Isotropically Radiated Power (EIPR) loss and Effective Isotropic Sensitivity (EIS) loss. The EIPR loss is a product of transmitter power and the antenna gain in a given direction relative to an isotropic antenna of a radio transmitter. The EIS is the measured sensitivity in a single direction. The Effective Isotropic Radiated Power (EIRP) loss and Effective Isotropic Sensitivity (EIS) loss is observed in the UE 200 due to mismatch in Intermediate frequency (IF) cable lengths from each RF module to a trans-receiver of the UE 200.

At 406, the RF module having lowest power loss is activated as a first RF module. In an embodiment, the RF module activator 256 is configured to activate the RF module having the lowest power loss as the first RF module. For example, the first RF module is used for communication with a serving cell (or serving beam).

At 410, a signal strength associated with the serving beam in the serving cell is determined. In an embodiment, the signal strength estimator 258 is configured to determine the signal strength associated with the serving beam (or serving cell 104) upon activating the first RF module by the RF module activator 256.

At 412, a determination is made whether the signal strength meets a first signal criteria. In an embodiment, the RF module antenna activation determiner 254 is configured to determine whether the signal strength associated with the serving cell or beam meets a first signal criteria. In one example, RF module activation determiner 254 is configured to determine whether the signal strength is below a first threshold value. The first threshold value indicates that a communication link between the UE 200 and the serving cell or beam 104 is weak and UE 200 may need to search for neighbor beam having a good signal strength. If the signal strength does not meet (no in operation 412) the first signal criteria, then the process of the determination as shown in block 410 is performed again.

At 414, at least one RF module from the remaining inactive RF module is selected. In an embodiment, the RF module activation determiner 254 is configured to select at least one RF module from the remaining inactive RF module in response to the determining that the signal strength associated with the serving beam 104 meets the first signal criteria. In an embodiment, the RF module activation determiner 254 is configured to select at least one RF module from the remaining inactive RF module continuously (or periodically) without using any signal criteria.

At 416, at least one neighbor beam is measured and the list of neighbor cell beams is created/updated based on the measurement. In an embodiment, the RF module activation determiner 254 is configured to measure at least one neighbor beam from a plurality of neighbor beams 106 of the serving cell 104 using at least one selected RF module. Further, the RF module activation determiner 254 is configured to create a list of available neighbor beams based on the measurements and store the list of available neighbor beams in a beam database stored in the memory 205.

At 418, a determination is made whether the signal strength meets a second signal criteria. In an embodiment, the RF module activation determiner 254 is configured to determine whether the signal strength associated with the serving cell beam 104 meets a second signal criteria. In an example, the RF module activation determiner 254 is configured to determine whether the signal strength is below a second threshold value. The second threshold value indicates that a communication link between the UE 200 and the serving cell or beam 104 is very weak and UE 200 need immediate switching to neighbor cell beam having a good signal strength for avoiding a beam failure scenario. If the signal strength does not meet the second signal criteria (no in operation 418), then the process iterates to block 414.

At 420, one or more fields related to the list of available neighbor beams is retrieved. In an embodiment, beam switcher 260 is configured to retrieve one or more fields from the list of neighbor beams, wherein the one or more fields include neighbor cell beam band (Ncell beam Band), neighbor cell beam frequency (Ncell beam freq), neighbor cell beam identity (Ncell beam id), a direction of beam including theta and phi angles, a RF module identity number, strength of signal by corresponding RF module.

At 421, a gain and a beam direction of each RF module is determined. In an embodiment, RF module gain determiner 266 is configured to determine the gain of each of the plurality of RF modules (220). The gain of each RF modules depends on a number of antenna elements in corresponding RF module. In an embodiment, the RF module having more number of antenna elements has high gain. In an embodiment, the RF module gain determiner 266 is also configured to determine a beam direction associated with each RF module by measuring the theta and phi angles and signal strength received at the RF module.

At 422, at least one RF module is activated as the first RF module. In an embodiment, the beam switcher 260 enables the RF module activator 256 to activate the at least one RF module using the determined gain and the beam direction.

At 424, a plurality of RF module other that the first RF module is deactivated. In an embodiment, the RF module activator 256 is configured to deactivate the plurality of RF module other than the first RF module.

At 426, the communication from the serving cell beam switched to one of neighbor cell beams having the higher signal strength from the first RF module. In an embodiment, the beam switcher 260 is configured to switch the communication from the serving cell beam to one of neighbor cell beam using the activated RF module.

The various example embodiments disclosed herein can be implemented using at least one hardware device and performing network management functions to control the elements.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

According to various example embodiments, a method of operating a user equipment (UE) in a wireless network includes: activating, by the UE, a first RF module from a plurality of RF modules available at the UE for communication with a serving beam in a serving cell, wherein remaining RF modules from the plurality of RF modules are inactive, selecting, by the UE, at least one RF module from the remaining inactive RF modules, measuring at least one neighbor beam from a plurality of neighbor beams of each neighbor cell through the selected at least one RF module; and switching the communication from the serving beam to the at least one neighbor beam based on the measurement in response to determining that a signal strength associated with the serving beam meets a signal criteria.

According to various example embodiments, creating a list of available neighbor beams for each neighbor cell based on the measurements.

According to various example embodiments, the switching comprises: retrieving, by the UE, one or more fields related to the list of available neighbor beams, wherein the one or more fields include at least one of information of neighbor cell beam band, neighbor cell frequency, neighbor cell beam identity, a direction of beam including theta and phi angles, a RF module identity number, or strength of signal by corresponding RF module, activating, by the UE, at least one RF module from the remaining inactive RF modules using the retrieved one or more fields; and switching, by the UE, the communication from the serving beam to the at least one neighbor beam using the activated at least one RF module.

According to various example embodiments, the activating, by the UE, the at least one RF module comprises: determining, by the UE, a gain of each of the plurality of RF modules, wherein the gain of each RF module is based on a number of antenna elements in corresponding RF module, and wherein the RF module having a higher number of antenna elements has high gain, determining, by the UE, a beam direction associated with each RF module by measuring the theta and phi angles and signal strength received at the RF module; and activating by the UE, the at least one RF module based on the determined gain and beam direction.

According to various example embodiments, the activating the first RF module from the plurality of RF modules comprises: estimating, by the UE, a power loss associated with each of the plurality of RF modules; and activating by the UE, the RF module having a lowest estimated power loss.

According to various example embodiments, continuing communication with the serving beam using the first RF module in response to determining that the signal strength associated with the serving beam does not meet the signal criteria.

According to various example embodiments, a user equipment (UE) includes: a plurality of Radio Frequency (RF) modules, a memory; and a processor, communicatively coupled to the memory, and the plurality of RF modules, the processor is configured to: activate a first RF module from the plurality of RF modules available at the UE for communication with a serving beam in a serving cell, wherein remaining RF modules from the plurality of RF modules are inactive, select at least one RF module from the remaining inactive RF modules, measure at least one neighbor beam from a plurality of neighbor beams of each neighbor cell through the selected at least one RF module; and switch the communication from the serving beam to the at least one neighbor beam based on the measurement in response to determining that a signal strength associated with the serving beam meeting a signal criteria.

According to various example embodiments, the processor is configured to: create a list of available neighbor beams for each neighbor cell based on the measurements.

According to various example embodiments, the processor is configured to: retrieve one or more fields related to the list of available neighbor beams, wherein the one or more fields include at least one of information of neighbor cell beam band, neighbor cell frequency, neighbor cell beam identity, a direction of beam including theta and phi angles, a RF module identity number, or strength of signal by corresponding RF module, activate at least one RF module from the remaining inactive RF modules using the retrieved one or more fields; and switch the communication from the serving beam to the at least one neighbor beam using the activated at least one RF module.

According to various example embodiments, the processor is configured to: determine a gain of each of the plurality of RF modules, wherein the gain of each of the plurality of RF module is based on a number of antenna elements in corresponding RF module, and wherein the RF module having a higher number of antenna elements has high gain, and determine a beam direction associated with each RF module by measuring the theta and phi angles, and signal strength received at the RF module; and activate the at least one RF module based on the determined gain and the beam direction.

According to various example embodiments, the processor is configured to: estimate a power loss associated with each of the plurality of RF modules; and activate the RF module having a lowest estimated power loss.

According to various example embodiments, the processor is configured to: continue communication with the serving beam using the first RF module in response to determining that the signal strength associated with the serving beam does not meet the signal criteria.

According to various example embodiments, a user equipment (UE) includes a plurality of Radio Frequency (RF) modules, a memory; and a processor, communicatively coupled to the memory, and the plurality of RF modules, the processor is configured to: activate a first RF module from the plurality of RF modules available at the UE for communication with a serving beam in a serving cell, wherein remaining RF modules from the plurality of RF modules are inactive, select at least one RF module from the remaining inactive RF modules, in response to determining that a signal strength associated with the serving beam meeting a signal criteria, measure at least one neighbor beam from a plurality of neighbor beams of each neighbor cell through the selected at least one RF module; and switch the communication from the serving beam to the at least one neighbor beam based on the measurement.

The UE according to various embodiments may be one of various types of electronic devices. The UE may include, for example, a portable communication device (e.g., a smartphone), a computer device, a portable multimedia device, a portable medical device, a camera, a wearable device, a home appliance, or the like. According to an embodiment of the disclosure, the UE are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium (e.g., memory 205) that is readable by a machine (e.g., the UE 200). For example, a processor (e.g., the processor 210) of the machine (e.g., the UE 200) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A method of operating a user equipment (UE) in a wireless network, wherein the method comprises:
activating, by the UE, a first RF module from a plurality of RF modules available at the UE for communication with a serving beam in a serving cell, wherein remaining RF modules from the plurality of RF modules are inactive;
selecting, by the UE, at least one RF module from the remaining inactive RF modules;
measuring at least one neighbor beam from a plurality of neighbor beams of each neighbor cell through the selected at least one RF module; and
switching the communication from the serving beam to the at least one neighbor beam based on the measurement in response to the determining that a signal strength associated with the serving beam meets a signal criteria.

2. The method of claim 1, further comprising;
creating a list of available neighbor beams for each neighbor cell based on the measurements.

3. The method of claim 2, wherein the switching comprises:
retrieving, by the UE, one or more fields related to the list of available neighbor beams,
wherein the one or more fields include at least one of information of neighbor cell beam band, neighbor cell frequency, neighbor cell beam identity, a direction of beam including theta and phi angles, a RF module identity number, or strength of signal by corresponding RF module;
activating, by the UE, at least one RF module from the remaining inactive RF modules using the retrieved one or more fields; and
switching, by the UE, the communication from the serving beam to the at least one neighbor beam using the activated at least one RF module.

4. The method of claim 3, wherein the activating, by the UE, the at least one RF module comprises:
determining, by the UE, a gain of each of the plurality of RF modules, wherein the gain of each RF module is based on a number of antenna elements in corresponding RF module, and wherein the RF module having a higher number of antenna elements has high gain;
determining, by the UE, a beam direction associated with each RF module by measuring the theta and phi angles and signal strength received at the RF module; and
activating by the UE, the at least one RF module based on the determined gain and beam direction.

5. The method of claim 1, wherein the activating the first RF module from the plurality of RF modules comprises:
estimating, by the UE, a power loss associated with each of the plurality of RF modules; and
activating by the UE, the RF module having a lowest estimated power loss.

6. The method of claim 1, further comprising;
continuing communication with the serving beam using the first RF module in response
to determining that the signal strength associated with the serving beam does not meet the signal criteria.

7. A user equipment (UE) comprises:
a plurality of Radio Frequency (RF) modules;
a memory; and
a processor, communicatively coupled to the memory, and the plurality of RF modules, the processor is configured to:
activate a first RF module from the plurality of RF modules available at the UE for communication with a serving beam in a serving cell, wherein remaining RF modules from the plurality of RF modules are inactive;
select at least one RF module from the remaining inactive RF modules;
measure at least one neighbor beam from a plurality of neighbor beams of each neighbor cell through the selected at least one RF module; and
switch the communication from the serving beam to the at least one neighbor beam based on the measurement in response to determining that a signal strength associated with the serving beam meeting a signal criteria.

8. The UE of claim 7, wherein the processor is further configured to:
create a list of available neighbor beams for each neighbor cell based on the measurements.

9. The UE of claim 8, wherein the processor is further configured to:
retrieve one or more fields related to the list of available neighbor beams, wherein the one or more fields include at least one of information of neighbor cell beam band, neighbor cell frequency, neighbor cell beam identity, a direction of beam including theta and phi angles, a RF module identity number, or strength of signal by corresponding RF module;
activate at least one RF module from the remaining inactive RF modules using the retrieved one or more fields; and
switch the communication from the serving beam to the at least one neighbor beam using the activated at least one RF module.

10. The UE of claim 9, wherein the processor is further configured to:
determine a gain of each of the plurality of RF modules, wherein the gain of each of the plurality of RF module is based on a number of antenna elements in corresponding RF module, and wherein the RF module having a higher number of antenna elements has high gain; and
determine a beam direction associated with each RF module by measuring the theta and phi angles, and signal strength received at the RF module; and
activate the at least one RF module based on the determined gain and the beam direction.

11. The UE of claim 7, wherein the processor is further configured to:
estimate a power loss associated with each of the plurality of RF modules; and
activate the RF module having a lowest estimated power loss.

12. The UE of claim 7, wherein the processor is further configured to:
continue communication with the serving beam using the first RF module in response to determining that the signal strength associated with the serving beam does not meet the signal criteria.

13. A user equipment (UE) comprises:
a plurality of Radio Frequency (RF) modules;
a memory; and
a processor, communicatively coupled to the memory, and the plurality of RF modules, the processor is configured to:
activate a first RF module from the plurality of RF modules available at the UE for communication with a serving beam in a serving cell, wherein remaining RF modules from the plurality of RF modules are inactive;
select at least one RF module from the remaining inactive RF modules;
in response to determining that a signal strength associated with the serving beam meeting a signal criteria, measure at least one neighbor beam from a plurality of neighbor beams of each neighbor cell through the selected at least one RF module; and
switch the communication from the serving beam to the at least one neighbor beam based on the measurement.

14. The UE of claim 13, wherein the processor is further configured to:
create a list of available neighbor beams for each neighbor cell based on the measurements.

15. The UE of claim 14, wherein the processor is further configured to:
retrieve one or more fields related to the list of available neighbor beams, wherein the one or more fields include at least one of information of neighbor cell beam band, neighbor cell frequency, neighbor cell beam identity, a direction of beam including theta and phi angles, a RF module identity number, or strength of signal by corresponding RF module;
activate at least one RF module from the remaining inactive RF modules using the retrieved one or more fields; and
switch the communication from the serving beam to the at least one neighbor beam using the activated at least one RF module.

16. The UE of claim 15, wherein the processor is further configured to:
determine a gain of each of the plurality of RF modules, wherein the gain of each of the plurality of RF module is based on a number of antenna elements in corresponding RF module, and wherein the RF module having a higher number of antenna elements has high gain; and
determine a beam direction associated with each RF module by measuring the theta and phi angles, and signal strength received at the RF module; and
activate the at least one RF module based on the determined gain and the beam direction.

17. The UE of claim 13, wherein the processor is further configured to:
estimate a power loss associated with each of the plurality of RF modules; and
activate the RF module having a lowest estimated power loss.

18. The UE of claim 13, wherein the processor is further configured to:
continue communication with the serving beam using the first RF module in response to determining that the signal strength associated with the serving beam does not meet the signal criteria.
